(19) United States
(12) Patent Application Publication
(10) Pub. No.: US 2023/0406349 A1
(43) Pub. Date: Dec. 21, 2023

(54) VEHICLE COMMUNICATION ADAPTIVITY

(71) Applicant: FORD GLOBAL TECHNOLOGIES, LLC, Dearborn, MI (US)

(72) Inventors: Stuart C. Salter, White Lake, MI (US); Meghan Preiss, Detroit, MI (US); Pietro Buttolo, Dearborn Heights, MI (US); Brendan F. Diamond, Grosse Pointe, MI (US); Lia Pillen, Woodhaven, MI (US); Yejin Han, Detroit, MI (US)

(21) Appl. No.: 17/841,264

(22) Filed: Jun. 15, 2022

(51) Int. Cl. B60W 60/00; G01C 21/34; B60W 40/09

(52) U.S. Cl. CPC B60W 60/0011; G01C 21/3446; B60W 40/09; B60W 2540/30; B60W 2540/229

(57) ABSTRACT

A vehicle analyzes buffered content, buffered by the vehicle, to determine if any content includes one or more predefined characteristics designated to trigger an offer to re-route the vehicle to review the content including the one or more predefined characteristics. The vehicle, responsive to at least one item of the buffered content including the one or more predefined characteristics, for at least one item of the content including the one or more predefined characteristics, determines if an alternative route exists. The alternative route may have at least one of at least one characteristic projected to permit autonomous driving for a duration, or at least having sufficient projected delays associated therewith of the duration, the duration being a duration sufficient to review the content based on a projected review time of the content. The vehicle, responsive to determining the alternative route exists, presents the route to a vehicle driver for acceptance.

### TECHNICAL FIELD

The illustrative embodiments generally relate to vehicle communication adaptivity.

### BACKGROUND

With vehicles having a suite of connectivity options, as well as onboard displays and taskable outputs, users are becoming capable of using a vehicle as a mobile office. This concept may become even more important as users seek to work from home, but are not always staying at home for a full work day. If the user can take meetings and handle business in a vehicle while driving and while appropriate, the flexibility afforded by such vehicles can allow the user to perform daily travel tasks while fulfilling all work-related requirements.

Problematically, many such requirements include face-to-face meetings and/or conference calls that may include both video and visual presentations. Users focused on driving cannot give as much consideration to such things, as their efforts remain focused on the road. Autonomous vehicles can help alleviate the need to drive oneself, but such systems may only function in certain areas or environments as a partial or full proxy for an active human driver.

Stoplights also provide a brief opportunity to review text messages, scan an email, etc. Stoplights are unpredictable, however, and a user has no particular assurances that lights will provide an opportunity. Moreover, when a user begins a journey, they may actually seek a route having the fewest delays, and only when traveling may they become aware of a situation that requires their consideration, even if in brief spurts. Accordingly, the fastest route may be sub-optimal for providing the user with desired delays during which emails can be read and which provide delays sufficient for message response.

### SUMMARY

In a first illustrative embodiment, a vehicle includes one or more processors configured to receive incoming content from a source external to the vehicle. The processors are configured to analyze the content to determine whether a current driver consideration level, based on a current driving scenario, permits immediate replay of the content based on a projected amount of consideration required by the content. The processors are also configured to when the projected amount of consideration required by the content exceeds a threshold for immediate viewing based on a current driver consideration level, buffer the content. Also, the processors are configured to, for at least one item of buffered content, determine if an alternative route to a current route exists, with projected sufficient delays to review the content based on a projected review time of the content, and, responsive to determining the alternative route exists, present the route to a vehicle driver for acceptance.

In as second illustrative embodiment, a vehicle includes one or more processors configured to receive incoming content from a source external to the vehicle. The processors are further configured to analyze the content to determine whether a current driver consideration level, based on a current driving scenario, permits immediate replay of the content based on a projected amount of consideration required by the content. Also, the processors are configured to, when the projected amount of consideration required by the content exceeds a threshold for immediate viewing based on a current driver consideration level, buffer the content. The processors are additionally configured to, for at least one item of buffered content, determine if an alternative route to a current route exists, with at least one characteristic projected to permit autonomous driving for a duration sufficient to review the content based on a projected review time of the content, and, responsive to determining the alternative route exists, present the route to a vehicle driver for acceptance.

In a third illustrative embodiment, a vehicle includes one or more processors configured to analyze buffered content, buffered by the vehicle, to determine if any content includes one or more predefined characteristics designated to trigger an offer to re-route the vehicle to review the content including the one or more predefined characteristics. The one or more processors are also configured to, responsive to at least one item of the buffered content including the one or more predefined characteristics, for at least one item of the content including the one or more predefined characteristics, determine if an alternative route to a current route exists. The alternative route has at least one of at least one characteristic projected to permit autonomous driving for a duration, or at least having sufficient projected delays associated therewith of the duration, the duration being a duration sufficient to review the content based on a projected review time of the content. The processors are further configured to, responsive to determining the alternative route exists, present the route to a vehicle driver for acceptance.

### BRIEF DESCRIPTION OF THE DRAWINGS

FIG. 1 shows an illustrative example of a vehicle computing system with incoming data streams;

FIG. 2 shows an illustrative data-handling process;

FIG. 3 shows an illustrative route negotiation process;

FIG. 4 shows a second illustrative data-handling process; and

FIG. 5 shows an illustrative buffer handling process.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Recognizing that driver consideration needs, or even desires, may change over the course of a journey, the illustrative embodiments provide methods and apparatuses for handling incoming communication and creating situations that maintain driver awareness, but also adapt to changing driver communication needs as the vehicle travels.

For example, a person going to the store could get an urgent email from a boss, or a string of text messages from friends. This person had no way of knowing that this would occur when they began a journey, and users do not typically seek out routes with numerous short delays in case messaging occurs. Nonetheless, such routes do exist. While timing of lights and other traffic control features may not be completely possible, many lights run on fixed patterns, and there is also a general assumption that a light with many routes has a higher likelihood of incidental delay than a light with no routes.

Alternatively, if the user has self-drive autonomous capability, that feature may only function under certain conditions. The route that includes such conditions may be sub-optimal if a user is directly driving, but may be a useful route that could free up intervals of at least a few minutes, if not more, for a user to respond to messages or other communication.

Even if a user knows about a meeting, the user may think the meeting is largely verbal in nature, and may be comfortable driving while talking. But if the meeting suddenly involves video or slide presentation, the user may be unable to participate because of both local laws and the inadvisability of watching a video or slide deck while driving. Active incoming communication monitoring can mitigate the temptation to do this, as well as buffer the content for viewing at a more convenient time. At the same time, a vehicle can adjust a route plan to provide intervals for rapid response by creating intentional delays or detours that allow for autonomous driving opportunities during which the user can review buffered content. The vehicle can be adaptive and reactive to both the receipt of such content and the general volume of the buffer, and can dynamically create opportunities for review when a buffer is filling, as well as a get a user quickly back on a more efficient route when the buffer is diminished or empty.

Historical route data, traffic data and times-of-day travel data can be used to provide expected delays for a given route segment, and a routing process intentionally designed to create delays can take both live and historical information into account when planning a route that has a certain amount of desired or requested delays. At the same time, a user requiring a five minute delay to read a text and respond may not want to become mired in lengthy construction delays, so the routing may accommodate this. On the other hand, a user involved in a video chat may want a slow-moving situation that allows for autonomous driving or adaptive cruise control driving at slow speeds, allowing the user to be more engaged in the conversation while still slowly moving towards an intended destination, making the overall use of time more efficient.

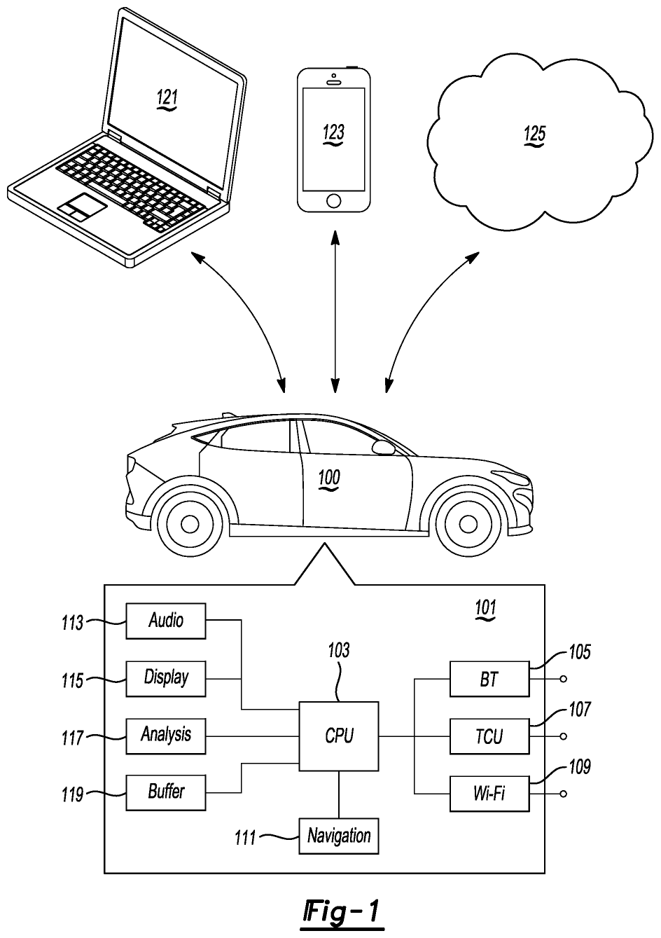

FIG. 1 shows an illustrative example of a vehicle computing system with incoming data streams. In this example, the vehicle will handle incoming data, such as chats, messages, emails, calls, videos, etc., but it is also possible to handle this information in the cloud if desired and buffer excess data in the cloud, and then provide the data to the vehicle when the vehicle is ready to receive and present the data. While the example is from the perspective of the vehicle, mobile devices, portable computers and cloud-based systems can also handle the data. For example, an application on a mobile device or portable computer could handle the data and buffer the data onboard the device. Then, if a user arrived at a destination prior to viewing all the data, the device could be carried outside the vehicle for later viewing, with the buffer intact.

In many instances, the incoming data stream will be through the mobile device in any event, if the vehicle is not using an onboard cellular connection, and mobile devices will already provide portable access to emails and texts in most instances. But, an additional application could buffer other data not traditionally stored by the mobile device and allow that data to be portable as well. That way, if the user could no renegotiate a route, or if the new route did not provide the anticipated delays, the user could still port the data to a next-location. In other instances, the vehicle, if the vehicle is buffering data, could offer to load the data to a portable device when a vehicle arrived at a destination or was otherwise parked or powered down. In still further instances, if the vehicle were connected to a Wi-Fi network, for example (e.g., parked in a home garage), the user could stream the data from a buffer onboard the vehicle without having to port the data to a mobile device, which may have limited memory reserved for other applications. The vehicle could be powered in a limited capacity to provide this streaming on request, and the vehicle could determine whether it was connected to such a connection prior to attempting to load the data to the mobile device, so the user could see the full suite of available viewing options for buffered data.

In the example shown in FIG. 1, the vehicle 100 includes an onboard computing system 101, which has one or more processors 103 associated therewith, as well as communication transceivers such as BLUETOOTH 105 and Wi-Fi 109. The vehicle 100 may also include a telematics control unit (TCU) 107, which can include a cellular modem connection and which may enable the vehicle to use cellular communication through an onboard data plan or using a user's paired mobile device.

The vehicle system 101 may also include a navigation process 111, which can provide generalized navigation as well as task-specific navigation such as will be discussed herein. The navigation process may be capable of accommodating requests for specific or general delays, and may be capable of finding “sub-optimal routes” (from a speed and duration perspective) that are likely to provide any delays necessary for completion of a task. This can include accessing real-time traffic data, as well as using historical data modeling and light-timing data to determine which routes are likely to produce delays sufficient to meet user requests or provide time for review of buffered items.

The vehicle system 101 may include one or more audio 113 and visual 115 outputs, including large and small per-seat displays, as well as sectionable audio. One or more heads-up displays could also be provided for allowing display of information while a driver is watching the scene ahead, which may be useful during autonomous driving if the driver still wants to remain situationally aware.

The system 101 may further include an analysis process 117, which can determine the types of and consideration requirements associated with incoming data streams. Data not meeting a parameter for immediate display, because of preferences, general requirements, etc., may be buffered in a buffer 119. The analysis process may also periodically or continually review the data in a buffer to determine likely review durations, overall buffer volume, etc. Data may be presented out of order from receipt, based on data elements in the buffer having a review-time associated therewith corresponding to a projected stop-length.

The analysis process may include metadata tags with buffered data indicating likely consideration required, likely duration of review, type of data, etc. Users can use this information to quickly review buffer contents and request that delays be planned for certain items of interest. For example, a user may have 10 spare minutes in a journey, and may see that an email from work has a projected 8 minute review time. If the navigation process can accommodate, the user can be re-routed to create the necessary delays to review the item, and still reach a next planned stop within preferred timing (e.g., 10 extra minutes). On the other hand, if the item had a projected 30 minute review time, the user may elect to view the item later and proceed to the stop without attempted re-routing.

Sources of data can include, but are not limited to, conference calls from computers 121, other users sending texts or video chats from cellular phones 123, information delivered over the cloud 125, such as emails, video, etc. Users may even want to view a TV program or other content at stop intervals, if generally permissible, and the system could buffer the content to skip streaming delays when the vehicle was at intermittent rest or when autonomous driving could be engaged. This could also allow users to buffer sporting events or other content where the user may want to see the outcome prior to reaching a point where someone is likely to disclose the outcome, while at the same time not showing the user consideration-consuming content at inappropriate moments. If users are presently tempted to use phones or other devices to live-stream content while driving, knowing that the content could be partially or fully viewed during stops along a re-routed route may encourage the user not to engage in other less-advisable behavior.

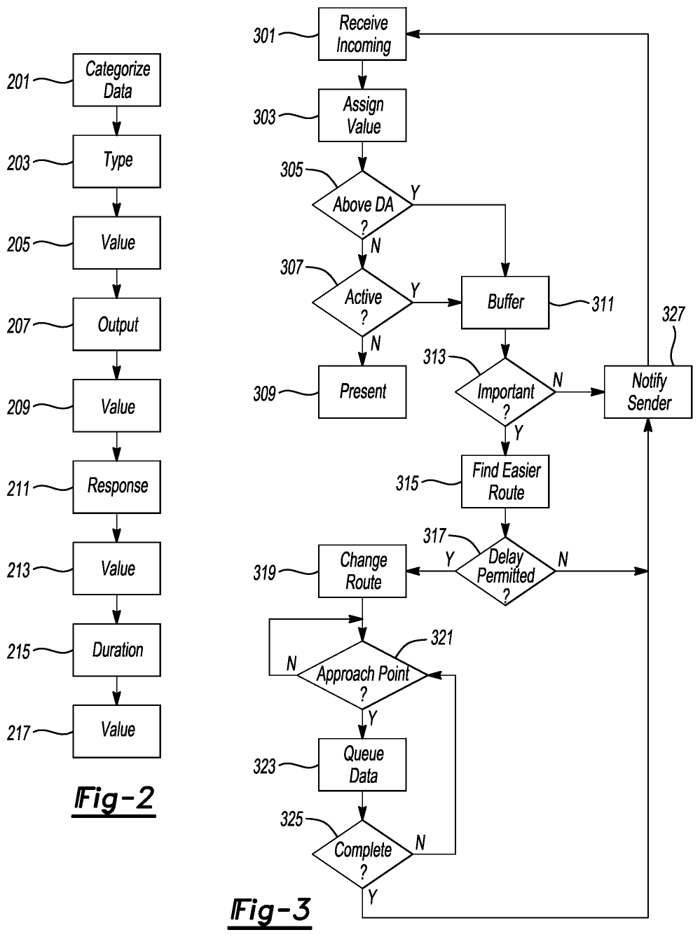

FIG. 2 shows an illustrative data-handling process. In this example, the process receives incoming data and begins categorizing the data at 201. This process can create metadata to be appended to the data as it is buffered and/or aid in determining which data can be consumed more immediately. In this example, classifications include adding values to data as an additional data element, and the net aggregate value can be compared against a driver demand level, which can include a prediction of how much focus a driver currently requires based on a driving scenario and how much focus a driver may require over an upcoming scenario that is, for example, the length of the data.

For live-generated data, such as an ongoing meeting, the data itself may not have a duration but the duration can be a predicted consumption duration related to time expected to consume data, or a duration of the meeting, for example. In an instance where there is no fixed end to the data, such as a spontaneous request for video chat, the data can be treated as having a predefined duration value based on what is occurring in a driving sense—e.g., the value can be 0 if the vehicle is stopped, but can go to infinite when the vehicle moves, because the nature of the video chat may be such that it is difficult to responsibly consume the data while traveling, and later review of a one-sided conversation may be fruitless. That is, lacking the driver as a participant, the video chat may simply cease to exist, and so buffering it for later consumption may not make sense.

In this example, the process considers a type of data (e.g., text, audio, video, etc.) at 203 and assigns a type value at 205. For example, if driver consideration demand were measured on a scale of 1-10, text data may receive a 1, audio a 1, and video a 7, meaning that the requirement of video simply on the basis of video is likely to prevent viewing under most circumstances. By way of example and not limitation, if a driver's maximum demand were 10, for example, then a current driving situation could have a demand value that is added to the consumption value and if that number was above 10 (or a lower threshold), then maximum demand would be exceeded. So while audio may receive a 1, active audio (e.g., a call) may receive a 3, since a driver would need to participate. Users may be able to tune the various demand values within reason and/or set the demand thresholds—e.g., a parent may set a new driver threshold of 5, which means that no video could ever be viewed while in the vehicle and that even calls and static text could be difficult to view under that threshold.

When a vehicle is stopped, for example, demand based on driving may be 1 or even 0. Of course, if the net demand value were above 10 for content, that content would never be viewable. To accommodate this, the maximum demand value may be, if desired, set to slightly below the maximum threshold of the scale—e.g., if the sum of all factors was 15, the actual value would be set to 9.9 to allow viewing while stopped or in other circumstances where driving consideration demand was 0. Similarly, if a threshold was tuned down to 8, the maximum value might be set to 7.9, for similar reasons. This would permit consumption under circumstances where the user was literally required to do nothing with regards to the vehicle, but still help limit consumption under most other circumstances.

Types of output required may be considered at 207, with a similar value concept at 209. For example, a call may include video and audio, but may be processable as simply audio based on user preferences. This data could be valued twice, as audio for replay requiring a speaker, and as video and audio for review requiring both a display and audio. Use of displays that a driver cannot see may actually result in a negative value being added at 209, because of the diminished distraction to the driver. That could allow other occupants to view a video or call without having it blocked due to concerns about driver distraction.

If the requirement exists for responses, i.e., if the incoming data has an interactive element at 211, the value may be assigned at 213 as well. Non-interactive data may have a value of and the level of the value can be based on the required level of response—e.g., higher for 2 person calls and lower for a simple yes or no answer to a survey, for example. The duration, if known, can also be considered at 215, and a value assigned based on the duration at 217. Each of these and similar variables could be appended to the data as meta data, having their own variable values (e.g., the actual value of the classification variable) as well as the value assigned based on the classification variable and/or a net value in both absolute (the real sum) terms and maximum (the adjusted sum, as above) terms. That can allow for fast reconsideration of items in the buffer as well as rapid comparison of situations to buffered items for content recovery and replay in small time windows.

FIG. 3 shows an illustrative route negotiation process. In this example, the process receives incoming data at 301 and assigns some form of classification value at 303. That can be, for example, a value as above, or based on other schema for ranking, sorting and analyzing incoming content. A first pass filter may simply determine if the content is suitable for live replay, and then, if it is not, at that point a secondary buffering classifier may create classification data for the buffered data, if desired.

If the current level of driver consideration required for driving plus the value of the content based on the classifier (using the non-limiting example from FIG. 2) is above the permissible threshold at 305, the data may be buffered at 311. If the user is already engaged in data consumption at 307, the data may be buffered at 311. Otherwise, the data may be provided to the user for immediate consumption at 309.

Buffered data may have an importance flag associated therewith, which can include, for example, data from certain sources (e.g., work during the work day), certain contacts, of certain types, etc. Users may be able to define what characteristics create what levels of importance. At 313, the system considers whether any data in the buffer has an importance variable above a threshold, which in this example causes an automatic attempt to re-route the vehicle so the user can consume the data as rapidly as possible. Otherwise, the sender may be notified that the driver is occupied at 315.

If the data is important based on an algorithm, or if the user requests review of buffered data, the process may find one or more routes that require less driver consideration at 315. This does not necessarily require delays in a route, but may include routes that have less traffic where a driver can, for example, listen to audio while driving under their own power. The classifications of the data to be replayed can be considered when finding a route, and if the base value of the data is above a maximum threshold (requiring a driver consideration value of 0 to consume), the route may need to include stopping points for the user to consume the data, or autonomous driving points where autonomous driving can be accomplished without the driver having to intervene.

Such routes will often include delays, sometimes by design, and the process also determines if a delay is permitted at 317. This can be accomplished by comparing a delay to a known acceptable parameter defined by the user, by querying the user once the predicted delay is known, by checking a user calendar for appointments that might be missed, etc. If the delay resulting from the change is permitted at 317, the process may change the route at 319, otherwise the process may notify the sender that review may be delayed because the user is in transit.

If the route is changed, the process may determine when a user is approaching a delay or low driver consideration point on the new route at 321 and queue the appropriate data for immediate replay once driver consideration required for driving drops below a threshold. This can repeat until review is complete at 325. While not necessary, this may save a few seconds in replay each time. Further, once review is completed, the process may resume a faster route with fewer delays unless a user indicates otherwise.

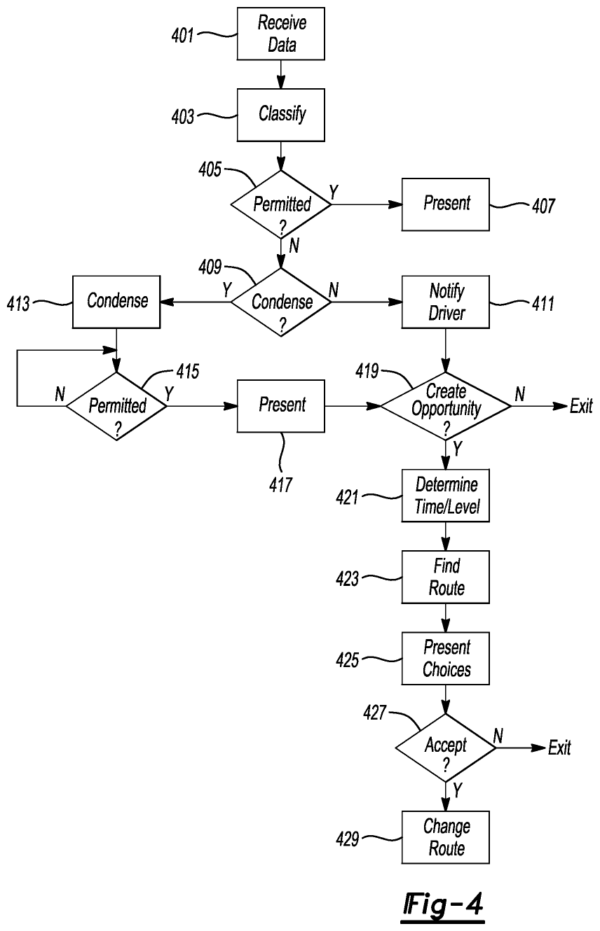

FIG. 4 shows a second illustrative data-handling process. This process is similar to the previous process in certain regards, but provides an additional example of how incoming data may be handled. In this example, the process receives incoming data at 401 and again performs some form of classification or analysis of the data at 403, to determine a relative effect on a driver based on characteristics of the data or a session involving the data.

If the data fits a model for immediate presentation, such as those discussed previously and the like, at 405, the process may present the data immediately at 407. It is worth noting that users may manually engage the filtering process at some point, and that they may be permitted to simply receive data as it comes in to be consumed or ignored at their own discretion. The filter is there for those who want active data handling and diminished distraction, but unless mandated, it is not something that would automatically be applied to every bit of incoming data unless that were a business decision.

In this example, the process may also be able to condense certain data. This can include skimming an email for keywords and/or a subject line, announcing several keywords in a text or contextualizing the text, etc. If the data is condensable, the process may provide the option to condense at 409 and, responsive to acceptance, condense the data into a summary form at 413, to be presented at 417 when permitted at 415. Based on that summary, for example, a user may elect to change a route at 419 to further review the data or leave the data buffered for later consumption.

If the data is not condensed or cannot be condensed, the process may notify the driver at 411 that data has been buffered. If appropriate, this can include an indication of type, source, length, etc. For example, a vehicle could announce “a video from Mom of 2:30 seconds in length has been buffered” or “a text from Samantha, projected to require 20 seconds of audio playback, has been buffered.” This may be in contrast to a summary of the text, which could be something like “a text from Samantha discussing weather and the stock market and a person named Marc, projected to require 20 seconds of audio playback, has been buffered.”

Upon knowing of the buffering, the driver may wish to create a review opportunity at 419. That would include a request to the navigation process to re-route the vehicle to a route wherein one or more aggregate opportunities to review the data may occur. Such a route may require significantly more than a detour of the duration of the playback, but the process can find one or more routes by determining total delay time or free consideration required at 421 and use those characteristics to find one or more present alternative routes at 423. These can be presented to the user as choices at 425, allowing the user to determine if the delay with the entire route change is worth the value in more immediately being able to consume the data. The routes may also have a threshold equal to a time remaining in a journey, so that no route creates more of a delay than the time it would take to simply complete a present journey and simply listen to the buffered content when the journey was done.

If the user accepts the alternative route at 427, which can also be a simply change of a few roads over to a more congested road, and does not always involve significant re-routing, the process can change an active route at 429 to the selected delay route.

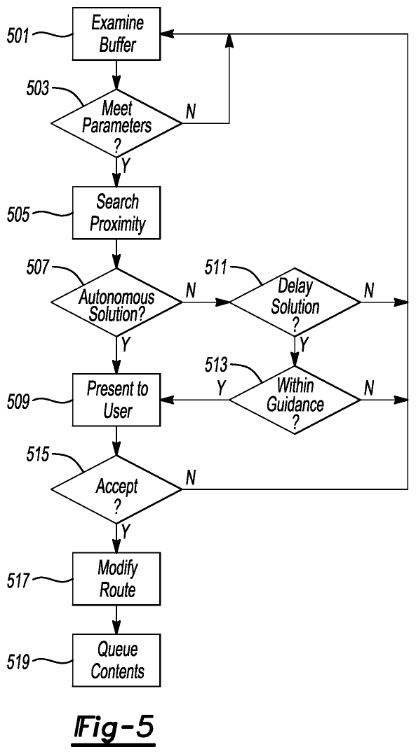

FIG. 5 shows an illustrative buffer handling process. In this example, the process will examine the buffer at 501 to determine the items of content that have been buffered. The driver may have certain parameters for creating consumption opportunities, and/or the system may look for items with certain parameters. For example, a driver may request that items from certain senders (work, spouse, etc.) trigger the remainder of the process, and may also merge parameters, such as “any content from work,” “any content from spouse less than 2 mins of review,” “any content from school referencing Judy or Jane,” etc. The buffer review process can examine buffered content for sender, duration, specific context, etc. Context need not be directly referenced either, and can be inferred, such as the driver flagging “any content related to concert ticket sales” and the content being from a ticket sales company and/or referencing a specific act, but may not necessary mention ticket sales.

The vehicle may also try to deplete the buffer when possible, by finding spot opportunities for review of short duration content, such as a 0.3 mile detour to encounter a red light with a delay or a straight traffic-free road where the vehicle can drive itself for several minutes. Accordingly, the vehicle can search for “content with less than 1 minute expected review time.” Of course, the vehicle could search for any reasonable parameters, and this is just one example.

If any buffered content meets parameters for re-routing at 503, the process may search in a reasonable proximity at 505. The proximity may be maximally bounded by detours that would require more detour time than remains in a total route, i.e., the user probably doesn't want a 30 minute detour to review 10 minutes of content when the user will otherwise arrive at a destination in 10 minutes and would thus theoretically be 10 minutes ahead if the user did nothing after arrival except review the 10 minutes of content. In that sort of scenario, the system could add the content review time to the present route and then only find routes that had predicted arrival times earlier than the result of the additions—so that the user would presumably be “net ahead” on time.

In appropriately equipped vehicles, the process may first look for autonomous driving opportunities at 507, since those do not necessarily intentionally create delays and may be a comparable route with better AV driving characteristics. If such a route exists, the route can be presented to the user at 509. Additionally or alternatively, the process may look for delay solutions at 511, which are routes predicted to include some number of delays sufficient to review one or more items of content (at a single delay point or across multiple delay points). The user may also have maximum detour lengths set, such as “no more than 15 minutes” or “no more than X % of a current route's remaining time.” Hard parameters may also be set, such as calendar appointments and historical arrival times, wherein no delay is permitted to create arrival later than those fixed times.

If the delay route meets any guidance parameters at 513, the route can be presented to the user at 509. Presentation may also include indication of what content is projected to be consumable with the delay, and/or a selection of various content predicted to be consumable if more than one type of consumable content that fits within the delay exists. If the user accepts the new route at 515, the process can modify the route at 517 and queue any content to be played back at 519.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
one or more processors configured to:
receive incoming content from a source external to the vehicle;
analyze the content to determine whether a current driver consideration level, based on a current driving scenario, permits immediate replay of the content based on a projected amount of consideration required by the content;
when the projected amount of consideration required by the content exceeds a threshold for immediate viewing based on a current driver consideration level, buffer the content;
for at least one item of buffered content, determine if an alternative route to a current route exists, with projected sufficient delays to review the content based on a projected review time of the content; and
responsive to determining the alternative route exists, present the route to a vehicle driver for acceptance.

2. The vehicle of claim 1, wherein the content includes at least one of video content, audio content, a conference call or text content.

3. The vehicle of claim 1, wherein the analysis of the content in light of the current driver consideration level includes a projected driver consideration level for the projected review time of the content, to determine if a driver consideration level is projected to remain below a threshold necessary to view the content for the duration of the projected review time.

4. The vehicle of claim 1, wherein the delays are based on traffic control features known along the alternative route.

5. The vehicle of claim 4, wherein timing of the traffic control features is known.

6. The vehicle of claim 1, wherein the delays are based on present traffic levels along the alternative route.

7. The vehicle of claim 1, wherein the delays are based on historic traffic levels along the alternative route.

8. A vehicle comprising:
one or more processors configured to:
receive incoming content from a source external to the vehicle;
analyze the content to determine whether a current driver consideration level, based on a current driving scenario, permits immediate replay of the content based on a projected amount of consideration required by the content;
when the projected amount of consideration required by the content exceeds a threshold for immediate viewing based on a current driver consideration level, buffer the content;
for at least one item of buffered content, determine if an alternative route to a current route exists, with at least one characteristic projected to permit autonomous driving for a duration sufficient to review the content based on a projected review time of the content; and
responsive to determining the alternative route exists, present the route to a vehicle driver for acceptance.

9. The vehicle of claim 8, wherein the content includes at least one of video content, audio content, a conference call or text content.

10. The vehicle of claim 8, wherein the analysis of the content in light of the current driver consideration level includes a projected driver consideration level for the projected review time of the content, to determine if a driver consideration level is projected to remain below a threshold necessary to view the content for the duration of the projected review time.

11. The vehicle of claim 8, wherein the at least one characteristic includes a road characteristic designated as suitable for autonomous driving.

12. The vehicle of claim 8, wherein the at least one characteristic includes a traffic characteristic designated as suitable for autonomous driving.

13. The vehicle of claim 12, wherein the traffic characteristic is determined based on present traffic levels along the alternative route.

14. The vehicle of claim 12, wherein the traffic characteristic is determined based on historic traffic levels along the alternative route.

15. A vehicle comprising:
one or more processors configured to:
analyze buffered content, buffered by the vehicle, to determine if any content includes one or more predefined characteristics designated to trigger an offer to re-route the vehicle to review the content including the one or more predefined characteristics;
responsive to at least one item of the buffered content including the one or more predefined characteristics, for at least one item of the content including the one or more predefined characteristics, determine if an alternative route to a current route exists, with at least one of:
at least one characteristic projected to permit autonomous driving for a duration, or
at least having sufficient projected delays associated therewith of the duration, the duration being a duration sufficient to review the content based on a projected review time of the content; and
responsive to determining the alternative route exists, present the route to a vehicle driver for acceptance.

16. The vehicle of claim 15, wherein the predefined characteristics include a source that provide the content.

17. The vehicle of claim 15, wherein the predefined characteristics include a context associated with the content.

18. The vehicle of claim 15, wherein the predefined characteristics include a word included in the content.

19. The vehicle of claim 15, wherein the predefined characteristics include a duration of the content.

20. The vehicle of claim 15, wherein the predefined characteristics include a combination of at least two of: context associated with the content, duration of the content, a source providing the content, or a word included in the content.
